(19) United States
(12) Patent Application Publication
(10) Pub. No.: US 2005/0133153 A1
(43) Pub. Date: Jun. 23, 2005

(54) Poster as well as methods and materials for its manufacturing

(76) Inventor: Andre Fiechter, Hausen am Albis (CH)

Correspondence Address: KENYON & KENYON, ONE BROADWAY, NEW YORK, NY, 10004, US

(21) Appl. No.: 10/819,015

(22) Filed: Apr. 5, 2004

(30) Foreign Application Priority Data
Apr. 4, 2003 (CH) CH-606/03

(51) Int. Cl. B41M 1/00; B32B 31/00

(52) U.S. Cl. 156/277

(57) ABSTRACT

An adhesion compound suitable for use in the production of a non-adhesive one side see-through poster. The adhesion compound includes at least a poster material with a poster substrate and a carrier material with a carrier substrate, in which the poster material and the carrier material are separably connected together by an adhesive layer. The poster material has on a first side a printable or with an image receptive coating directly or after pre-treatment providable surface and on a second side a light absorbing surface, and the adhesive layer has a better adhesion towards the carrier material than towards the poster material such that after separation of the poster material and the carrier material the adhesive layer remains on the carrier material. Furthermore, the poster material has in at least an area regularly or in a regular pattern distributed holes, such that it is see-through from the second side with the light absorbing surface.

### CROSS REFERENCE TO RELATED APPLICATIONS

This application claims the priority of Swiss patent application no. 606/03, filed Apr. 4, 2003, the disclosure of which is incorporated herein by reference in its entirety.

### FIELD OF THE INVENTION

The present invention relates to an adhesion compound which is appropriate for manufacturing graphical products, especially for one-sided printed graphical products which can be seen through from the other side, as well as such a graphical product and a method for manufacturing such products.

### BACKGROUND INFORMATION

Products with a thin foil may be referred to as transfer images. Such products may comprise a plastic foil with an adhesive which is protected by a removable liner, the liner being a silicone coated paper or a plastic liner. When the product is being used, the liner will first be removed such as to uncover the adhesive and the sticky side of the product will then be fixed on the specified area. The disadvantage of such sticky foils is that the liner will be thrown away after the foil has been fixed on the desired area. Moreover, the complete removal of such foils, or of such adhesive, respectively, can be problematic. A further disadvantage is that the picture which has been applied on such a foil is either opaque or the contrast is unsatisfying. Also already known are transparent cling foils that can be applied to smooth surfaces, such as glass, and that can be removed without leaving traces of adhesive (see e.g. GB 2 217 256). Also these foils have to be protected by a liner up to their use, since otherwise they would cling to each other or to themselves.

WO 00/56556 describes non-adherent image carriers that are part of a set further comprising a double sided adhesive carrier. The adhesive carrier may have good adhesion to the substrate and releasable adhesion to the image carrier, such that the image carrier can be replaced by another one while the adhesive carrier remains in place.

GB 2 244 585 A discloses a poster to be stuck on a window comprising a cling or self-adhesive layer on one side of a transparent material and at least one printed matter comprising layer as well as a one-colored layer, the adhesive poster being perforated.

Also already known are one sided see-through, punched self-adhesive foils that on the other side are provided with an image. U.S. Pat. No. 5,609,938 discloses one-way vision display panels that are perforated plastic panel assemblies having a rear surface provided with a light absorbing color coating and a front surface carrying an image. In specific embodiments, either a white opaque intermediate panel may be present or a light reflective image may be applied onto a black substrate. Such image carrying panel assembly is then provided with an adhesive and a peelable layer and the whole assembly is perforated. As an alternative to a panel that on one surface is provided with adhesive, a panel comprising a static cling material may be used, and as an alternative to a plastic panel assembly a display panel assembly may comprise a single perforated membrane, printed on one side with a light reflective color image and printed or coated on a reverse side with a light absorbing dark color coating.

Another embodiment, in particular for interior mounting, is described in WO 99/65680. The graphic article described therein is made of a perforated imaginable film layer and a non perforated attachment component. The graphic article is produced in that the perforated imaginable film layer composed of an opaque light absorbing layer and an opaque, which may be a light reflecting layer with an imaginable surface that is imaged and then the imaged surface is adhered to a heat activated adhesive layer of the attachment component that on the second surface has a layer of pressure-sensitive adhesive. On the light absorbing side a non perforated transparent protective foil can be provided.

The self-adhesive foils described above usually are intended for being applied to the interior or exterior surface of a window.

Also with these foils, the liner on which such foils are delivered, will be thrown away after the application, and also with these foils the removal from the surface on which they have been stuck, or their replacement, respectively, can be a problem because the adhesive used for the fixation, on the one hand needs to have an adequately good adhesion to ensure that the foil cannot easily be peeled off under environmental influences or due to mild vandalism, respectively, but on the other hand, after a certain time, it should be easily removable without leaving traces and under application of special, mild methods of removal. The trace-less removal is important since the transparency of foils subsequently applied on the same surface should not be affected.

Further disadvantages of these self-adhesive, one sided see-through foils are that their application has to be done on specific surfaces and, on the manufacturing side, the liner that is punched simultaneously with the self-adhesive foil will be disposed as rubbish.

Furthermore, if the perforated foils are imaged, color may pass through the perforations and pollute the light absorbing surface, thereby affecting the through view.

Thus, there is still a need for one-side transparent (see-through), on the other side image carrying graphical products and intermediates and production methods that do overcome the above mentioned disadvantages.

### SUMMARY OF THE INVENTION

Hence, it is a general object of the invention to provide an adhesion compound suitable as intermediate in the production of a poster material or poster of the present invention.

It is a further object of the present invention to provide a poster material that has regularly allocated holes and a surface which is printable on the first side and a surface which is light absorbing on the second side, and whereby the poster material has an adhesion coating neither on the first nor on the second side.

It is still another object of the present invention to provide a poster wherein the poster material carries information on the light reflecting, first side.

It is yet another object of the present invention to provide a method for the preparation of such a poster.

It is still another object to provide a method for producing a printable adhesion compound.

Now, in order to implement these and still further objects of the invention, which will become more readily apparent as the description proceeds, the adhesion compound suitable as intermediate in the production of a non-adhesive, one-sided see-through poster material or poster of the present invention is manifested by the features that it comprises at least a poster material with a poster substrate and a carrier material with a carrier substrate, wherein the poster material and the carrier material are separably connected together by an adhesive layer, and wherein the poster material has on a first side a printable or with an image receptive coating directly or after pre-treatment providable surface and on a second side a light absorbing surface, and wherein the adhesive layer has a better adhesion towards the carrier material than towards the poster material such that after separation of the poster material and the carrier material the adhesive layer remains on the carrier material, and wherein the poster material has in at least an area regularly or in a regular pattern distributed holes, such that in separated form it is see-through from the second side with the light absorbing surface.

The poster material or poster of the present invention has no adhesive properties at all, i.e. also no electrostatic or other adhesion properties, such as so called “cling” properties.

Specific embodiments of the adhesion compounds of the present invention comprise one or any reasonable combination of two or more of the following additional features, whereby such additional features can make the compound suitable as intermediate in another step of a poster production method.

For use as intermediate in the poster production method, an inventive adhesion compound comprises a poster material wherein the side facing the carrier material is the second side with the light absorbing surface. In one embodiment, the first side of the poster material has a printable surface. In another embodiment that may also be a precursor of the before described embodiment, the fist side of the poster material has a surface that can be directly provided with an image receptive coating. In yet another embodiment, the first side of the poster material can be provided with an image receptive coating after pre-treatment.

For connecting the poster material to the carrier material, the adhesion compound is provided with an adhesive layer arranged between the poster material and the carrier material the adhesive layer showing a better adhesion against the carrier material than against the poster material such that after separating the poster material and the carrier material, the adhesive layer remains on the carrier material.

In an exemplary adhesion compound of the present invention, the holes are perforation holes or punching holes, respectively.

In one embodiment of an intermediate adhesion compound, the first side of the poster material has a first surface that is also light reflective. This light reflective surface can be provided by a light reflective poster material or by a light reflective coating/layer or by a light reflective print.

If suitably equipped, the carrier material present in the perforation step can also be used, namely as a one side information carrying from the other side see-through product of the state of the art, i.e. for images (information) that can be fixed on e.g. window panes. In this case, the carrier material has a first side with a surface which is printable or that can be provided with an image receptive coating directly or after pre-treatment, and a second side with a surface which is light absorbing.

As the first side of the poster material also the first side of the carrier material can have a surface which is also light reflecting. Such light reflecting surface of the carrier material can be provided as described above in connection with the poster material.

In an exemplary embodiment of the adhesion compound an adhesive layer is arranged between the carrier material and the poster material the adhesive layer having a better adhesion against the carrier material than against the poster material, and the light absorbing second side of the carrier material is facing the poster material.

In a specific adhesion compound intermediate of the present invention, both the poster material and the carrier material are in at least one area provided with regularly distributed holes, the holes may be perforation holes or punching holes, respectively, which may be identical holes, although it may also be that the holes are not all identical but form a regularly repeating pattern of holes.

In another adhesion compound intermediate of or for use in the present invention, the carrier material has no holes. This is e.g. the case in an adhesion compound intermediate prior to perforation or punching, respectively, or in an adhesion compound wherein after perforation or punching the perforated/punched carrier has been replaced by a protective carrier for protecting the light absorbing surface during the poster production steps during which the first side is provided with a light reflecting surface and/or an information such as an image and/or a text.

In a further adhesion compound of the present invention, the first side of the poster material is provided with information, especially an image and/or a text.

If the carrier shall not be disposed of, the first side of the carrier material of an inventive adhesion compound can have a surface which is printable or which features an image receptive coating. The surface of the first side of the carrier material of such an adhesion compound can then be printed on with information. If such information provided carrier has no holes, for see-through applications it should be at least partially transparent. If not transparent, the applications may be on opaque surfaces.

As already shortly addressed above, the surface of the first side and/or the surface of the second side of the poster material and/or the surface of the fist side and/or the surface of the second side of the carrier material may be light absorbing and/or light reflecting, respectively, e.g. due to at least one layer applied to the respective side having the required light absorbing or light reflecting properties.

In another embodiment, the surface of the first side and/or the surface of the second side of the poster material and/or the surface of the first side and/or the surface of the second side of the carrier material of an inventive adhesion compound are light absorbing and/or light reflecting due to dyeing of the poster substrate and/or of the carrier substrate.

In another embodiment of the adhesion compound the poster substrate and/or the carrier substrate are a compound material, particularly a laminate. This or these compound material(s) can be selected such that they provide at least one of the light reflecting or light absorbing surfaces, which may be both.

Two or three of the above described approaches may be used, e.g., to provide one or more of the light absorbing or light reflecting surfaces by coating, others by dyeing and/or using compound materials( ).

In exemplary embodiments of the inventive adhesion compound, the light reflecting surface of the first side of the poster material and/or the light reflecting surface of the first side of the carrier material appear white or metallized, and the light absorbing surface of the second side of the poster material and/or the light absorbing surface of the second side of the carrier material appear black. The metallized appearing surfaces may have such appearance due to an aluminum layer.

In order to be well see-through, the holes provided adhesion compound of the present invention is in at least one area of the poster material, and optionally of the carrier material, provided with regularly (evenly) distributed holes, in such a way that the holes show a diameter of 1 to 5 mm, which may be 1 to 2 mm and that the holes account for 30% to 60%, which may be 30% to 50% of the area provided with regularly distributed holes.

In particular in the case of the punched holes, the holes are round and may be identical.

Specific poster materials suitable for being used in specific adhesion compounds of the present invention comprise poster materials selected from the group comprising materials provided with or containing light absorbingly colored paper or light absorbingly coated paper, light absorbing, colored plastic foils, synthetic foils provided with or containing a light absorbing coating, materials being or containing more than one layered compound fabric, particularly paper and synthetic fabric, a compound fabric made of various synthetic fabrics, a compound made of paper and/or synthetic fabric and one or more further materials, pulp fabrics, especially an open work fabric made of textile- and/or synthetic fibers.

Specific carrier materials suitable for being used in specific adhesion compounds of the present invention comprise carrier materials selected from the group consisting of materials provided with or containing light absorbingly colored paper or light absorbingly coated paper, light absorbing, colored plastic foils, synthetic foils provided with or containing a light absorbing coating, materials being or containing more than one layered compound fabrics, particularly paper and synthetic fabric, compound fabrics made of various synthetic fabrics, compounds made of paper and/or synthetic fabric and one or more further materials.

In an exemplary embodiment, the poster material and/or the carrier material comprise at least one auxiliary coating, in particular a translucent separation/release layer and/or a protection layer on the second side of the poster material, and/or an auxiliary layer which improves the printability on the first side of the poster material and/or the carrier material.

In an exemplary embodiment, the inventive adhesion compound that has already been provided with information over the information has at least one additional layer, especially one or more protection layer(s) selected from the group comprising layers for improving the abrasion resistance, layers for enhancing the light fastness, layers for enhancing the weather fastness, layers for protection against graffiti, and two or more layers of the same or different kind.

In a further embodiment, the carrier material of the adhesion compound of the present invention is a carrier substrate that is sticky on both sides, whereby in this case both sides of such a carrier material are covered with poster material, in particular holes containing poster material. Dependent on the production step, also the carrier material can have holes.

In the embodiment with a both sides adhesive coated carrier material sandwiched between two poster materials, the carrier material usually is disposed of, since such material, if perforated, is not suitable for being used in the information printing step or as adhesive poster and if not perforated, it might be polluted during information printing such that it could only be re-used to a limited extent, or it could be delivered to the end user with the posters on it, if e.g. the simultaneous use of the posters of both sides were intended.

In an exemplary embodiment of the poster material, or such poster material comprising adhesion compound, the sum of all areas that are see-through from at least one side due to holes is at least 50% of the total area of the adhesion compound, which may be at least 75%, in particular at least 90%, and especially may be 100%.

It has to be understood that an adhesion compound of the present invention is always such that neither the surface of the poster material intended for printing nor the opposite surface of the carrier material are sticky. This means that either the carrier material has only an adhesive layer on one surface, or—in the case of two adhesive layers—the carrier material is sandwiched between two poster materials with non sticky sides intended for information print directed away from the carrier.

Also an object of the present invention is a poster material as defined above that has regularly arranged holes and a printable surface on the first side and a light absorbing surface on the second side, the poster material having an adhesion coating neither on the first side nor on the second side. The poster material may have no adhesive properties at all.

The poster material of the present invention may already has a light reflecting first side. In another embodiment light reflecting properties are subsequently applied, e.g. during the information providing step. In the scope of the present invention, a poster material provided with information on the first side, alternatively is also termed poster.

The adhesion compound may consists of or include perforated poster material with a light reflecting, in particular white first side and a light absorbing, in particular black second side, a continuous carrier material and an adhesive layer between the second side of the poster material and the carrier material, whereby the adhesive layer upon separating the poster material remains on the carrier material.

Such adhesion compound can easily be printed by common printing equipment and separated from the carrier/liner material already at the printing site such that the carrier/liner material can easily be collected in large quantities for correct disposal, re-use or recycling.

A poster of the present invention can be produced in that a printable adhesion compound
comprising at least a poster material with a poster substrate and a carrier material with a carrier substrate, the poster material and the carrier material being separably joined together by an adhesive coating, the poster material having on a first side a printable surface that is light reflecting and on a second side a light absorbing surface, the poster material furthermore comprising holes at least in one area such that after separation from the carrier material it is one-sided see-through and does not comprise any adhesion coating,
is printed with information on the first side of the poster material and optionally on the first side of the carrier material, and in that optionally a protection layer is applied to the printed surface of the poster material and optionally to the optionally printed surface of the carrier material, and in that finally the poster material is separated from the carrier material.

Since a non adhesive poster shall be produced, also the poster substrate and the poster material are non adhesive.

A printable adhesion compound can be produced in that a poster material that is one-sided see-through in at least one area and that has on a first side a printable surface or a surface that can be directly provided with an image receptive coating or a surface that after pre-treatment can be provided with such coating and that has on a second side a light absorbing surface, is separably stuck to a hole-free (non-perforated, continuous) carrier material by means of an adhesive layer. If the first side is not per se printable, it is provided with an image receptive coating, and if it is not yet light reflecting, it is directly or after application of an image receptive layer provided with a light reflecting coating or layer.

In the exemplary method of the present invention, the poster material that is one-sided see-through in at least one area is produced in that poster material comprising on a first side a printable surface, and on a second side a light absorbing surface, is provided with holes in at least one area by perforation. Alternatively to a poster material with printable surface, a poster material with a surface directly provided with an image receptive coating, or with a surface that after pre-treatment is provided with such coating can be applied.

The poster material being one-sided see-through in at least one area can be produced by using a starting or base adhesion compound comprising at least a poster material with a poster substrate and a carrier material with a carrier substrate, the poster material and the carrier material being separably connected to each other by an adhesive layer such that after separation from the carrier material the poster material shows no adhesive layer, the poster material having on a first side a printable surface and on a second side a light absorbing surface, the starting or base adhesion compound being provided with holes in at least one area by means of a perforation that goes through the complete starting or base adhesion compound, the such generated adhesion compound then being separated to give a perforated poster material and a perforated adhesive carrier material. Alternatively to the poster material with a printable surface, a poster material with a surface that is directly provided with an image receptive coating or a surface that after pre-treatment can be provided with such coating are suitable.

The method of the present invention also may comprise the steps that the base adhesion compound is made by providing a hole-free poster substrate with a light absorbing coating on its second side and optionally with a printable coating or an image receptive coating on its first side, and that the poster material is separably connected with a carrier material, whereby after separation from the carrier material the poster material does not comprise any adhesive layer.

A method for producing an alternative base adhesion compound comprises separably connecting a hole-free poster substrate to a carrier material, wherein the poster material is produced in that a laminate of a light absorbing layer and a printable layer or a layer that is directly or after pre-treatment providable with an image receptive coating is produced, and wherein after separation from the carrier material the poster material does not have any adhesive layer.

In an exemplary method, the carrier material used has on a first side a printable coating or a surface that is directly or after pre-treatment provided with an image receptive coating and on a second side a light absorbing surface. The method of the present invention may also comprise further steps during which the first side of the carrier material is provided with a printable coating or, optionally after pre-treatment, with an image receptive coating and on a second side with a light absorbing surface.

The carrier material used in the inventive method may be provided with an adhesion coating on the light absorbing surface of its second side.

The poster material and optionally the carrier material may in any step of the method for the production of a printable adhesion compound be provided with an image receptive layer/coating and/or a light reflecting surface and/or at least one auxiliary layer/coating, provided that such layer/coating does not affect the further use of the compound (e.g. an auxiliary layer/coating that improves abrasion resistance, or protects against graffiti but is not well printable should not be applied in an early step but only after information printing).

An exemplary method of the present invention is a material and cost saving method using specific adhesion compounds having in at least some steps a carrier material that has not to be discharged but that can be used in other applications, e.g. a perforated carrier as a poster material for one-side see-through adhesive posters, non perforated carriers as adhesive posters for use on opaque surfaces.

A poster produced as described above that is printed on one side and that can be seen through from the other side can be hung-up or put-up in a room in various ways, e.g. stabilized—if need be—by a frame or placed against—but not adhered to—a glass pane, or hung in a room without any additional stabilization.

### BRIEF DESCRIPTION OF THE DRAWINGS

FIG. 1 shows a scheme of the method for the production of a poster described in the present invention wherein the poster material gets punched without additional carrier/liner.

FIG. 2 shows a variant of the procedure of Figure 1, wherein the poster material attached to a self-adhesive carrier material gets punched.

FIGS. 3A-3F show cross sections of poster material in different phases of the process.

FIG. 3A shows the poster substrate.

FIG. 3B shows the poster substrate of FIG. 3A provided with a light absorbing layer.

FIG. 3C shows the poster material of FIG. 3B with an additional layer e.g. a separating layer.

FIG. 3D shows the poster material of FIG. 3C after perforation.

FIG. 3E shows the perforated poster material during its application onto a non-perforated carrier/liner material, the carrier/liner material being provided with an adhesive layer.

FIG. 3F shows the poster material of FIG. 3E in completely laminated condition.

FIG. 4 shows a cross section of the adhesion compound of FIG. 3F after application of an image receptive layer and an image.

FIG. 5 shows a cross section of the adhesion compound shown in FIG. 3F, wherein the poster material is directly provided with an image.

FIG. 6 shows a cross section of the release of the finished poster of FIG. 5 from the self-adhesive carrier.

FIG. 7 shows the step of the application of a poster made of a poster material including an image receptive layer to e.g. a window pane.

FIG. 8 shows a cross section of the poster analogous to the one of FIG. 6 with a protective layer applied over the image.

FIG. 9 shows a cross section of a similar embodiment as shown in FIG. 8 whereby the protective layer is a continuous protective film.

FIGS. 10A-10C show a cross sections of a material saving alternative, the material saving being due to using a carrier/liner material that is on both sides provided with an adhesive layer and thereon mounted poster material;

FIG. 10A shows such a material in delivery status.

FIG. 10B shows the material shown in FIG. 10A during the release of one poster.

FIG. 10C shows the material shown in FIG. 10B after complete removal of the first and beginning removal of the second poster.

FIG. 11 shows a cross section of a material of the state of the art for the production of a sticking poster.

FIGS. 12A-12D show cross sections of the improvements of the present invention.

FIG. 12A shows an inventive adhesion compound, wherein a one-sided, light absorbing poster material, that is not coated with adhesive, is used for protecting the adhesive layer, or as alternative to the liner of the material of FIG. 11, respectively.

FIG. 12B shows the material of FIG. 12A in punched condition.

FIG. 12C shows the punched material of FIG. 12B during separation of the adhesive coated material from the not adhesive coated poster material.

FIG. 12D shows the application of a new, non-perforated, adhesive coated carrier onto the adhesive-free poster material of FIG. 12C.

FIGS. 13A-13D show an analogous material whereby in this case the poster material does not have to be perforated since it is a translucent fibrous material e.g. textures.

FIG. 13A shows the one-sided, black coated fibrous material,

FIG. 13B shows a cross section of the one-sided, black coated fibrous material with the black layer adjacent to an adhesive carrier/liner layer.

FIG. 13C shows a cross section of the fibrous material that is provided with an image applied onto an adhesive carrier/liner that also caries an image.

FIG. 13D shows a cross section of the disconnection of the adhesion compound of FIG. 13C.

### LEGEND OF THE FIGURES

1 poster substrate (material)
2 carrier/liner substrate (material)
3 surface/side 1 of the poster material/substrate
4 surface/side 2 of the poster material/substrate
5 surface/side 1 of the carrier material/substrate or liner material/substrate
6 surface/side 2 of the carrier material/substrate or liner material/substrate
16 fibrous material (long grain)
16A fibrous material, (short grain)
20,20′ adhesive layer
21 information/image on carrier/liner
23 separation/release layer
24 image receptive layer
29 removable carrier/liner
30 information/image
32 light absorbing layer
34 protective layer
46 hole cutting tool/die cutting tool
50 hole
70 roll
71 transportation roll
72 window pane

Definitions

In order to ensure that the terms used herein are interpreted as intended, some definitions are given below:

Poster material/poster substrate designates a material that possesses the therefor mentioned features. It can consist of a poster substrate or it can comprise several additional layers, provided that the minimum features attributed to the poster material are fulfilled. The way of manufacturing, or the kind of the application of the layers/coatings, respectively, is irrelevant.

Carrier material/liner material/carrier substrate/liner substrate designates at least a carrier/liner material/substrate, yet can also be a material comprising diverse layers/coatings, provided that the minimum features attributed to the carrier material are fulfilled. The way of manufacturing, or the kind of the application of the coatings/layers, respectively, is irrelevant.

Within the scope of the present invention, a material is designated a substrate, if it provides all features requested for the poster material or the carrier material, or if it is a bearing or integral constituent, respectively, of these materials, that together with other layers or coatings forms the materials. Materials suitable to be used as substrates are e.g. metals, plastics, glass, cellulose products, such as paper or cardboard, synthetic papers, textures, non woven fabrics as well as multi-layer materials e.g. coextrusion products and laminates made from one or more of the previously mentioned materials.

Light absorbing means that at least 60% of the impinging light gets absorbed, which may be 80%, particularly 100%.

Light reflecting means that at least 60% of the impinging light gets reflected, which may be 80%, particularly 100%.

Coating means a layer material that is applied to another material in liquid or solid form. Examples of coatings include adhesive coatings, primer coatings, release coatings (e.g. silicones), light absorbing coatings such as black pigmented plastic coatings, light reflecting coatings such as white pigmented plastic coatings and metalizations. Methods for the application/attachment of coatings are printing, reverse roll coating, blade coating etc. A coating is in contrast to a substrate—not a bearing or integral constituent, i.e. it is neither responsible for the shape nor for the mechanical strength.

Non-adhesive, non-adherent means that there is neither an adhesive coating nor electrostatic forces leading to an adhesion on specific surfaces.

The terms “holey” “perforated, “provided with holes”, “punched”, “perforated”, “die cut” all describe materials wherein material-containing and material-free areas alternate in a regular pattern whereby some of the terms specify products that have been produced by a specific manufacturing step or a method. The term “holey” is used to designate a material that is translucent/see-through due to any kind of holes, i.e. it encompasses open-work textiles as well as originally continuous material that has been provided with holes by perforation, punching, die cutting etc.

In the scope of the present invention, hole means every material-free area or opening, respectively, in a material. Holes may be made directly during the production of e.g. textures or interlaced yarns, or they can be made subsequently by hand or machine. They can have several shapes, e.g. round, multigonal or polygonal, regular or irregular, symmetric or asymmetric, and within one area different hole shapes, hole patterns and hole sizes can occur provided that the eye recognizes the structure or its sequence as regular.

Regular in relation to the arrangement of the holes means that the transparency is not affected due to irregularities. The regularity of holey fibrous material is mostly lower than the regularity of perforations. The regularity of perforations should be such that the material thickness between proximate holes, or hole paths, respectively, varies by at most 20%, which may be by at most 10%, which may be by 0%.

Auxiliary layers may e.g. be primer-coatings, adhesive coatings within the poster material or the carrier material, respectively, separating/release coatings that facilitate the separation of materials, and barrier coatings that prevent an undesired mixing of materials/diffusion. Auxiliary layers may be provided as additional layers wherever required or necessary.

Additional layers are e.g. layers/coatings that improve the end product (the poster) yet have no impact on the adhesion compound and its usage during the manufacturing process of the poster. Such coatings in particular are protective layers that are used above the information for its protection or for the generation of special effects. Such layers are in particular layers that serve for the reduction of abrasion, for the increase of light resistance, for the increase of weather resistance and/or for the protection against graffiti.

The terms “side” and “surface” in relation to the poster material, the carrier material or the adhesion compound, respectively, are largely used synonymous.

The description of a surface as being light absorbing or light reflecting or appearing light absorbing or light reflecting includes also surfaces that comprise colorless or transparent, respectively, coatings/layers between the light absorbing or light reflecting coatings and the surface, or between the light absorbing or light reflecting substrates and the surface.

In the specification, the term “adhesion compound” is used for all materials that at least comprise one poster material and one carrier material and that are separably joined together. Depending on the step of the method in which they appear, they may be further specified, e.g. as basic adhesion compound for an adhesion compound that is provided with holes, as perforated adhesion compound for an adhesion compound that comprises holes passing through the whole compound, and as printable adhesion compound for an adhesion compound that comprises all coatings and characteristics which are at least desirable for the application of information. Any of the adhesion compounds of the present invention is suitable as an intermediate in different steps of the production of a non adhesive poster of the present invention.

### DETAILED DESCRIPTION

The inventive adhesion compound that is suitable for being used in the production of a non-adhesive, one-sided see-through poster comprises at least a poster material with a poster substrate 1 and a carrier material with a carrier substrate 2 wherein the poster material and the carrier material are separably joined together by an adhesive layer 20, and wherein the poster material has on a first side a printable or with an image receptive coating directly or after pre-treatment providable surface 3 and on a second side a light absorbing surface 4, and wherein the adhesive layer 20 has a better adhesion towards the carrier material than towards the poster material such that after separation of the poster material and the carrier material the adhesive layer 20 remains on the carrier material, and wherein the poster material has in at least an area regularly or in a regular pattern distributed holes 50, such that it is see-through from the second side with the light absorbing surface 4.

Within the scope of the present invention, several process intermediates are referred to as adhesion compounds, provided that they comprise the above mentioned characteristics.

An inventive adhesion compound may e.g. comprise a poster material that is translucent/see-through (open-work, perforated) due to regularly spread material-comprising areas and material-free areas (holes 50).

Such arrangement of material-comprising areas and material-free areas may occur e.g. in a regular fibrous material or it can be created by the means of perforation of a previously non-translucent/not-see-through, persistent material.

In an exemplary embodiment of the adhesion compound the side of the poster material facing the carrier material is the second, light absorbing side 4. This is in particular the case when the adhesion compound comprises a poster material already having holes 50 on a continuous carrier 2.

In one embodiment of the adhesion compound, the poster material has on its first side a surface 3 that is directly printable with information and in another embodiment it comprises a surface 3 that can be provided with an image receptive layer/coating 24. The surface that can be provided with an image receptive coating 24 can be directly furnished with the image receptive layer/coating 24 or after a pre-treatment e.g. a primer treatment and/or a corona treatment etc. of the surface.

A poster material with printable surface 3 may for example be a printable material such as paper or a material on which an image receptive layer/coating 24 has already been applied e.g. a foil coated with an ink jet layer. A surface 3 being able to be provided with an image receptive layer 24 may be any surface that allows to be coated or otherwise combined with or connected to a respective layer by means of fluid application, welding or laminating without harming the adhesion compound.

The adhesion of the poster material on the carrier material may be obtained through e.g. extrusion, welding or by gluing, whereby for the gluing process an adhesive layer 20 is arranged between the poster material and the carrier material. The adhesive layer/coating 20 has a stronger adhesion towards the carrier material than towards the poster material. In particular in adhesion compounds with perforated poster material and continuous carrier material an adhesive layer 20 is in general present.

The poster material may be a poster substrate 1 or it may comprise such substrate 1. The poster substrate 1 may be a uniform material or a material compound, especially a laminate, made from equal or different materials, e.g. differently colored foils.

The first side of the poster material may possess a light reflecting surface 3, e.g. a light reflectingly provided foil that is part of the poster substrate 1, or a light reflective layer/coating or a light reflective print. Very light colors such as light yellow, light beige and especially white are generally considered as light reflecting. Light reflecting metalizations, such as aluminizations, may be used in order to obtain special effects.

Also the light absorbing surface 4 may especially be provided by a coating on the respective side of the poster material or by a suitably colored poster substrate 1 itself. Very dark colors, particularly black, are considered as suitably light absorbing. Any auxiliary layers that are applied on the light absorbing surface 4 such as layers which regulate the adhesion or increase the abrasion resistance and/or UV resistance shall not have an impact on the light absorption. Within the scope of this invention, such auxiliary coatings/layers are considered as belonging to the poster material.

A specific adhesion compound of the present invention has a carrier material with a first side or surface 5, respectively, that is printable and a second side or surface 6, respectively, that is light absorbing. The first side 5 of the carrier material may also have a light reflecting surface. Between the carrier material and the poster material such an adhesion compound in general has an adhesive layer/coating 20 with a stronger adhesion towards the carrier material than towards the poster material whereby the light absorbing second side 6 of the carrier material is turned towards the adhesive layer/coating 20 and the poster material.

The light absorbing or light reflecting surfaces 5, 6 of the carrier material may be generated according to the description above concerning the poster material. The carrier substrate 2 used for the carrier material may also be a material compound, particularly a laminate.

After perforation, the carrier material of such adhesion compound may be used as an adhesive, one sided transparent poster material according to the prior art. Besides of positive ecological effects (savings in material and energy) this leads to a bisection of the perforation costs and to savings at the materials costs (perforated carrier does not have to be discarded and disposed).

If the adhesive layer 20 is missing in an adhesion compound that with respect to the other features is as described before, then the poster material as well as the carrier material (if non-adhesive) may be processed to a poster according to the present invention with the above mentioned advantages. Compound materials that are separable and after separation are non-tacky and do not adhere to any surface by their own are known to the skilled person.

The poster material and/or the carrier material may be or may contain light absorbingly colored paper or paper coated with a light absorbing coating, or the poster material and/or the carrier material may be or may contain a light absorbingly colored plastic foil or a plastic foil coated with a light absorbing coating. Also suitable are materials that contain paper and/or plastic foil, e.g. multilayered composites made from paper and/or plastics, from different plastics or from paper and/or plastics and another material e.g. a metal or fibrous material. Suitable poster materials are also fibrous materials, in particular holey fabrics made from textile fibers and/or plastic fibers.

One possibility to provide the adhesion compound with holes 50, i.e. to make it holey, is by a perforation that during the production is performed through the whole adhesion compound and—in direction perpendicular to the direction of the perforation—in at least specific areas and which may be over the whole adhesion compound. Such a perforated adhesion compound is also an inventive adhesion compound. In a further production step, such an adhesion compound may be disconnected and the perforated material may be applied on a new, continuous (i.e. not holey) carrier material for simple printing and/or for protecting the light absorbing surface against pollution.

At a later stage of the production method, the first, light reflecting surface 3 of the poster material will be provided with information 30, particularly with an image and/or text. Such an adhesion compound carrying information is also an object of the present invention.

A very regular allocation of the material-free areas 50, the holes, is primarily essential in order to obtain on the one hand a good through sight and on the other hand a good visibility of the information, e.g. a clear picture. A very good combination of the two competing demands is obtained when the regularly allocated material-containing and material-free areas of the poster material, and optionally the carrier material, are such that the material-free areas have a diameter of 1 to 5 mm, in particular 1 to 2 mm, and the material-containing areas provide 30 to 60%, in particular 30 to 50% of the poster area whereby the sum of the material-free and the material-containing areas is 100%.

The material-free areas 50, the holes, may be round, and may also be identical. Such holes advantageously are perforation holes 50, punching holes 50.

In general, the sum of all areas with holes 50, e.g. the perforated area, is at least 50% of the total area of the adhesion compound or the poster material or poster, respectively, which may be at least 75%, which may be at least 90%, and especially may be about 100%, i.e. the whole poster material/poster may be see-through due to holes 50, possibly except a small area (“frame”) adjacent the edges.

In a further embodiment of the inventive adhesion compound, the light absorbingly and/or the light reflectingly colored material, or the material that is provided with a light absorbing and/or a light reflecting coating or layer may be provided with a transparent auxiliary layer, in particular with a separating/release layer 23 improving the separation of the carrier material or with a coating improving the printability.

Also a subject of the present invention is a nonadhesive/non-adherent poster material as described above that is provided with regularly allocated (distributed) holes 50 and that on the first side has a printable surface 3 or a surface 3 that may be provided with a printable layer/coating and that on the second side has a light absorbing surface 4, and whereby the poster material has neither on the first side 3 nor on the second side 4 an adhesive layer 20, in particular a poster material that on the first side 3 is light reflecting. It is especially favored when the poster material has already been made printable on the first side 3.

On the light reflecting first side 3, the poster material may carry information and is then generally referred to as a poster.

While with special printing machines directly printing on a holey poster material may be done, e.g. by sucking excessive color off the light absorbing side or by feeding the poster material to the printing facility simultaneously with and pressed on a protection material (e.g. a sucking paper or a soft plastic foil that due to its softness “seals” the holes), printing in an adhesion compound and subsequent disconnection may be better. Such a method is further described below taking into consideration different alternatives.

An adhesion compound comprising a poster material and a carrier material, whereby the poster material and the carrier material are separably combined with each other and whereby the poster material has on a first side a printable or with an image receptive layer directly or after pre-treatment providable surface 3 and on the second side a light absorbing surface 4, is perforated, in particular by dye cutting. This adhesion compound will then be disconnected and, depending on its actual equipment, the carrier material will either be discarded or be further processed as a poster material of the state of the art in a respective adhesion compound.

The inventive poster material obtained as described above may be applied to a continuous (not-holey) carrier with its second, light absorbing side 4. The continuous carrier possesses an adhesive layer 20 that may be totally residue free releasable from the poster material, i.e. the adhesive layer 20 totally remains on the carrier material. The adhesion compound then is subjected to coating steps/printing steps wherein—depending on the requirements—not yet existent-layers such as e.g. adhesion improving (primer) layers and/or a light reflecting printing or coating and/or an image receptive layer and/or a print of information and/or a protective layer are applied.

Alternatively, the poster material may be perforated alone, i.e. without carrier material, and to apply such material directly on a continuous, not perforated carrier for further processing, or to use appropriate holey fibrous material 16 as poster material in this step.

Provision may be made for a “both sides” adhesive coated carrier with poster material on both sides and to further process such a compound accordingly, e.g. in that successively first the one and then the other side are printed, or by simultaneously printing both sides in appropriately equipped facilities. Such “sandwich” type adhesion compound with continuous poster material can also be used in the perforation step.

After application of the information 30 and optionally a protective layer/coating 34, the poster may be separated from the carrier. Since bigger amounts of carrier material accumulate during production, it can relatively easy be collected and re-used or recycled.

The poster may then be leaned against a window or—if the material has sufficient stability—it may e.g. be hung up or erected in a shop-window. In case that the material itself is not sufficiently dimensionally stable, it may be stabilized by means of a frame that is not impacting the visibility and transparency, in particular by a clip-on picture frame.

Specific embodiments of the present invention will be further explained below by means of the Figures. These Figures merely represent examples of embodiments and shall not be construed as in any way limiting the invention described in the appended claims.

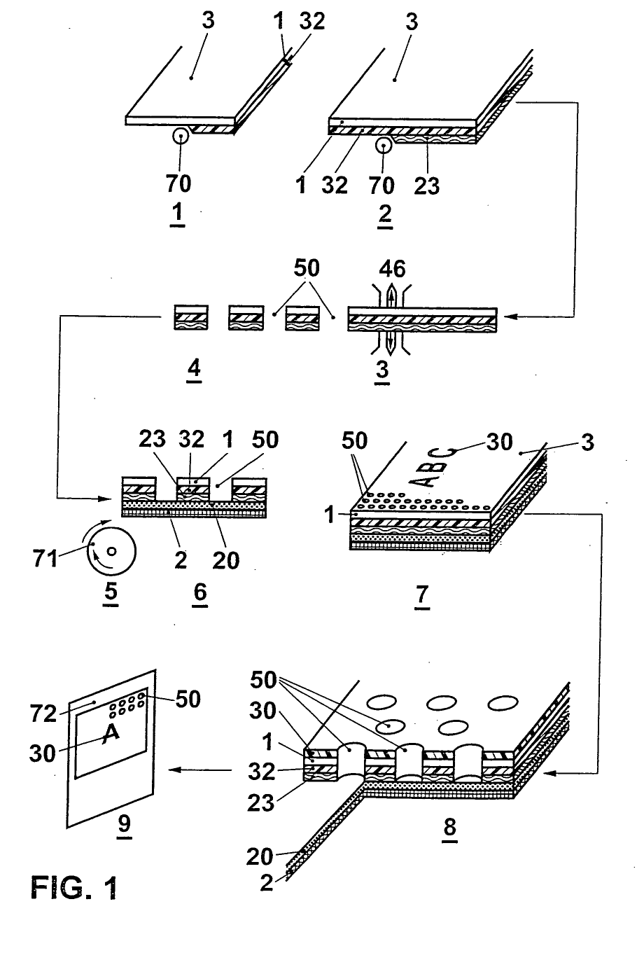

FIG. 1 shows in 9 steps a method for the production of a poster starting from a poster material that is perforated without a carrier.

Step 1 shows the application by means of a roller 70 of a light absorbing, in particular a black, coating 32 on a poster substrate 1. The application of such a coating 32 may be achieved through e.g. coating with fluid material or by laminating with an appropriate foil. The first side or surface 3 of the poster substrate 1 is suitable for the application of an image and/or other information 30 by means of printing methods. The result of this first step is a poster material as described above. Step 2 shows the poster material made in step 1 at the application of an auxiliary layer, in this case a separating/release layer 23, on the light absorbing layer 32. The separating layer has to be such that the respectively coated surface 4 of the poster material is still light absorbing. The separating/release layer 23 thus may also be a light absorbing layer or a colorless, transparent layer. This coating can also be applied as a fluid (liquid) or as a foil whereby the application of the layer as a fluid (liquid) may be used. Step 3 shows the perforation step whereby the perforating tool 46 is shown during the breakthrough of the poster material 1, 32, 23. The arrows indicate the direction of the perforation and the movement of the tool 46. Step 4 is a cross section representation of the poster material provided with holes 50 after the punching step. Step 5 shows a roller 71 with which an adhesive 20 and a carrier substrate 2, whereby here the carrier substrate 2 is identical with the carrier material, or an adhesive 20 coated carrier material, are applied to the poster material, and step 6 shows the resulting adhesion compound. The application of information 30 by means of printing methods takes place between the steps 6 and 7, and the perforated and printed adhesion compound is shown in step 7. Step 8 shows the disconnection of the adhesion compound and step 9 shows the final product, applied to a window pane 72.

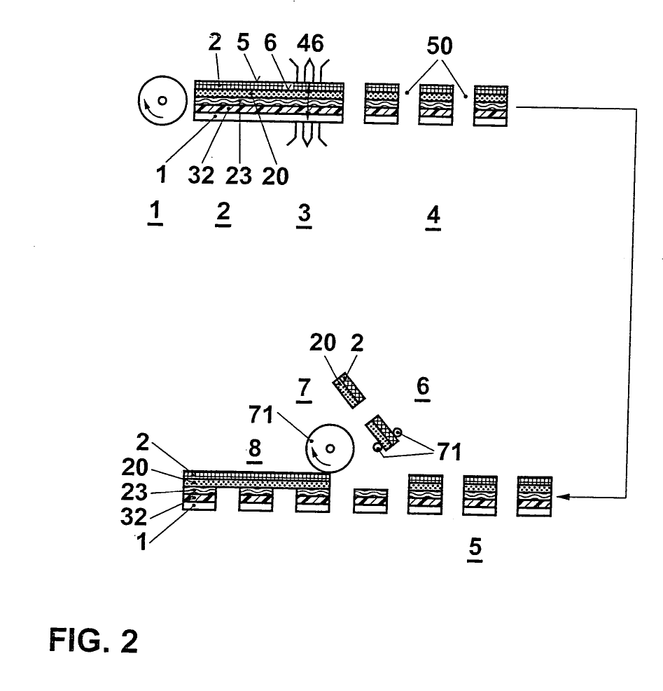

FIG. 2 shows different steps of the inventive method starting from an adhesion compound that prior to perforation has been provided with a carrier material.

Step 1 schematically illustrates a roll of adhesion compound having the construction described in step 2 in cross section. This base adhesion compound consists of (from top to bottom) a carrier substrate/carrier material 2, an adhesive layer 20 and a poster material made of a separating layer 23, a black layer 32 and a poster substrate 1. The carrier material may have a printable surface 5 that is turned away from the adhesion coating 20 and a light absorbing surface 6 that is turned towards the adhesive layer 20. In step 3 the die-cutting of the adhesion compound by means of the tool 46 is shown and in the steps 4 and 5 the completely perforated adhesion compound is illustrated. The steps 6 and 7 show the disconnection of the perforated adhesion compound and the application of the perforated poster material on a new, not perforated carrier material by means of adhesive layer 20 and with application of a transport roller 71 whereby a new adhesion compound is generated.

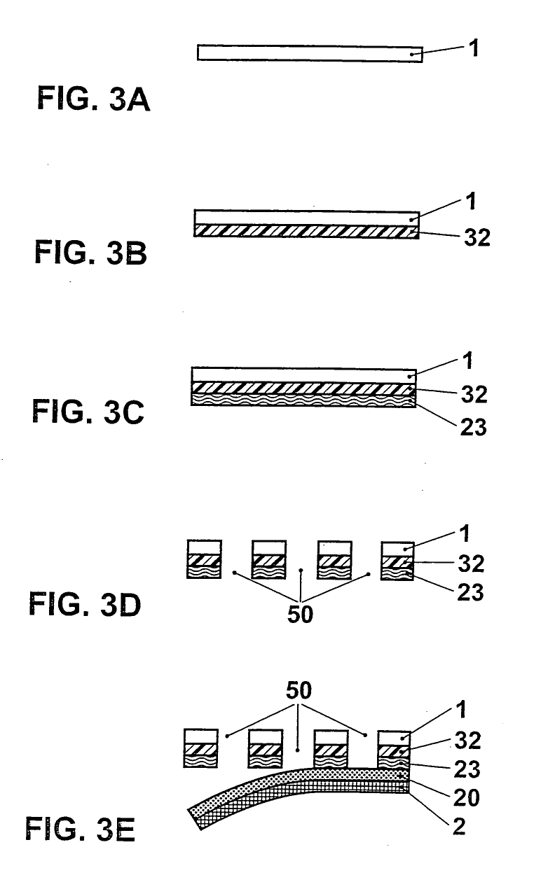

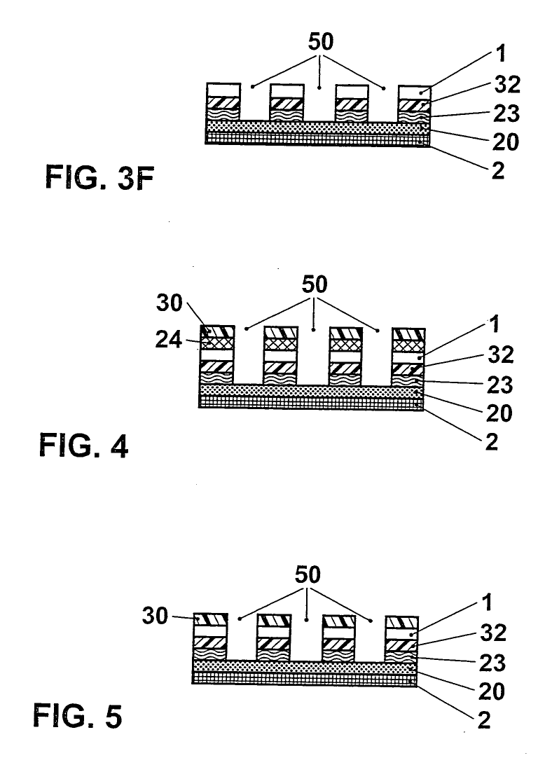

FIG. 3A shows a cross section through a poster substrate 1 that has been provided with a light absorbing coating 32 in FIG. 3B. FIG. 3C shows the material of FIG. 3B with an additional separating/release layer 23, e.g. a silicone layer. Such layer is only necessary if the adhesion of the adhesive on the carrier material is not sufficiently stronger than on the poster material or if an undesired (e.g. irregular) cohesive fracture would occur. FIG. 3D shows the material of FIG. 3C after application of holes and FIG. 3E shows how the poster material of FIG. 3C is stuck together with an adhesive layer 20 coated carrier such forming an adhesion compound wherein the separating/release layer 23 separably adheres to the adhesive layer 20. The adhesion between the separating layer 23 and the adhesive layer 20 may be adjusted such that the adhesion is just sufficient to survive the intended further steps of the method without any problems, in particular the printing of an information 30 and if necessary—previously the application of an image receptive layer 24. FIG. 3F finally shows the material produced according to FIG. 3E.

FIG. 4 shows the adhesion compound of FIG. 3F, wherein the surface 3 of the poster substrate 1 is not sufficiently well printable and therefore has to be prepared for the printing of information by applying an image receptive coating 24, after application of the image receptive coating 24 and the information 30.

FIG. 5 shows the material of FIG. 3F, wherein the surface 3 of the poster substrate 1 is directly suitable for the printing of information, after the application of information 30.

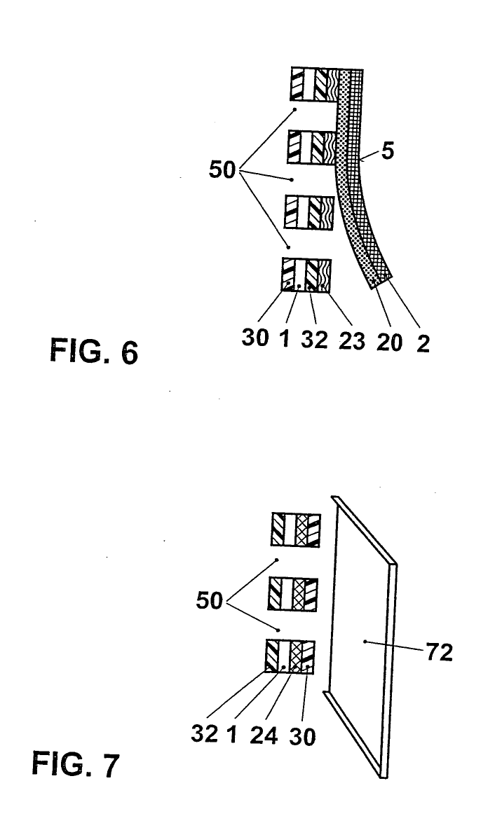

FIG. 6 shows a cross section through the material of FIG. 5 during separation of the finished poster from a self adhesive carrier 2,20. Provided that the self adhesive carrier 2,20 is not too badly soiled, it can be re-used again as a carrier. Alternatively, and not shown in the Figure, such a carrier can (provided that it is printably featured on the not adhesive coated side or surface 5), be provided with an information printing 21 (not shown here) either at a stage where it is still in the above described adhesion compound, or at a later stage joined to a liner. Such a printed carrier can be used as a common transfer image.

FIG. 7 schematically shows the step of attaching a poster onto a glass pane 72. The poster consists of a poster material comprising a light absorbing layer 32, a poster substrate 1 as well as an image receptive layer 24 and an information layer 30.

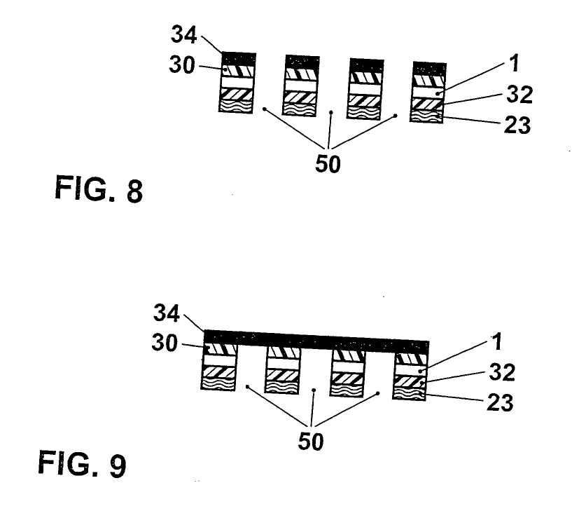

FIG. 8 shows a cross section through a poster analogous to the peeled off poster in FIG. 6 with an additional layer applied over picture 30, a protection layer 34. Here, the protection layer was applied in liquid form wherefore the holes 50 have also been formed. In this embodiment, it is not a must that the protection layer 34 is fully transparent and colorless but it may optionally contain a special effects generating filler that only mildly decreases transparency.

FIG. 9 shows a similar embodiment as FIG. 8 wherein the protection layer 34 applied is a continuous protection film, in particular a transparent, at least mostly colorless lamination foil.

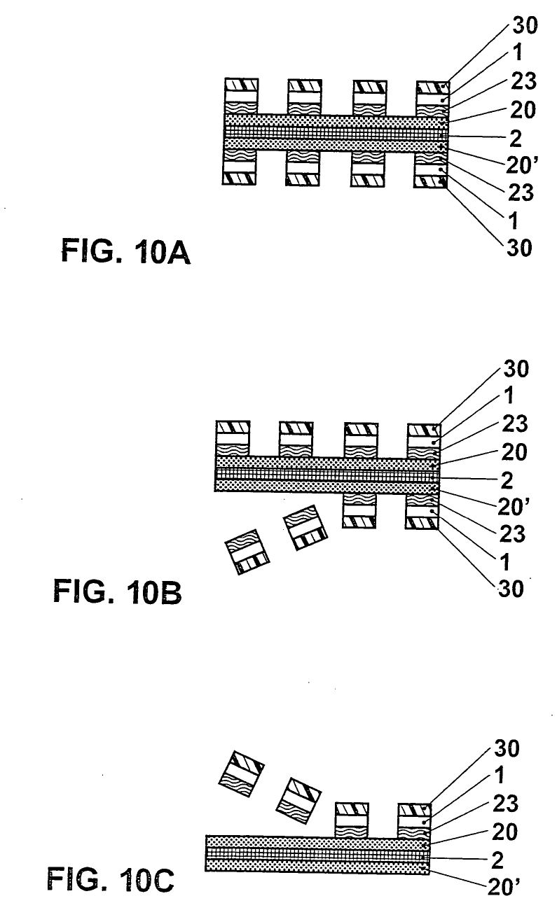

FIG. 10A shows a materials saving variant of an inventive adhesion compound as it might be delivered to the end user. In this embodiment, by using a carrier material that is on both sides coated with adhesive 20, 20′, two posters, either formed by a separating/release layer 23, a light absorbing poster substrate 1, and an information printing 30 on a white base coat, or formed by a poster substrate 1 being a laminate made of a light absorbing foil and a light reflecting foil, whereby the information 30 has been directly applied on the surface 3 of the light reflecting foil, can simultaneously be provided. This is e.g. reasonable if the information of the two posters is interrelated such that it has to be ensured that always the desired set is delivered to the end user, or if a carrier is desired to enhance the stability during transport. A respective sandwich that has not yet been provided with information 30 is also advantageous for the use in printing equipment suitable for more or less simultaneous front and back side printing, and thus for shipping from the adhesion compound manufacturing site to the printing facilities.

FIG. 10B shows the material of FIG. 10A during detachment of one of the posters and FIG. 10C shows the material of FIG. 10B after complete separation of the first poster and started detachment of the second poster. If the posters neither have interrelated information nor need stabilization during transport, they can be removed from the carrier already at the production site thereby improving the collecting and recycling of the carrier material.

An adhesion compound formed from a double sided sticking carrier material and two poster materials can also be used in the perforation step, if simultaneously, i.e. in one punching step, two inventive poster materials shall be perforated.

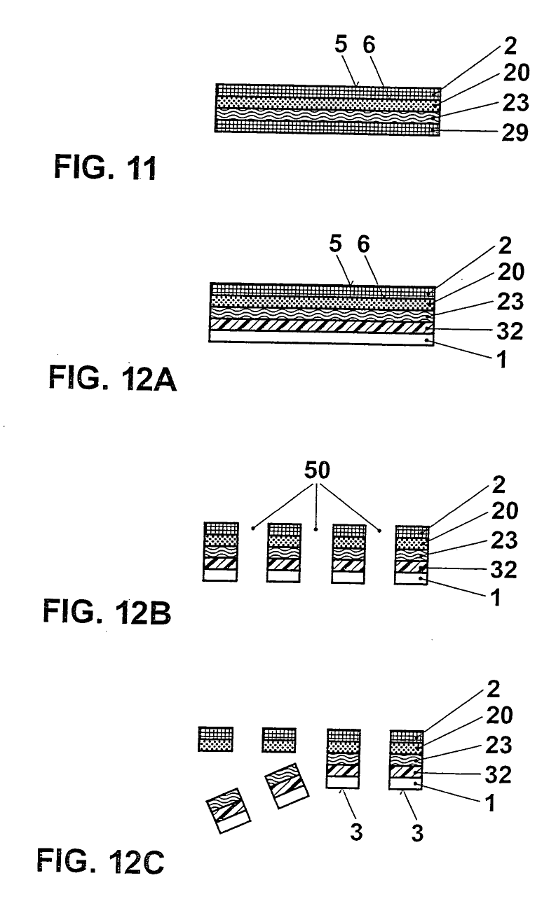

FIG. 11 shows a material of the state of the art for manufacturing of an adhesively bonding, one-sided see-through poster with a substrate 2 having a light reflecting, printable surface 5 and a light absorbing surface 6, and which comprises a usual removable carrier 29 instead of the poster material relevant according to the present invention.

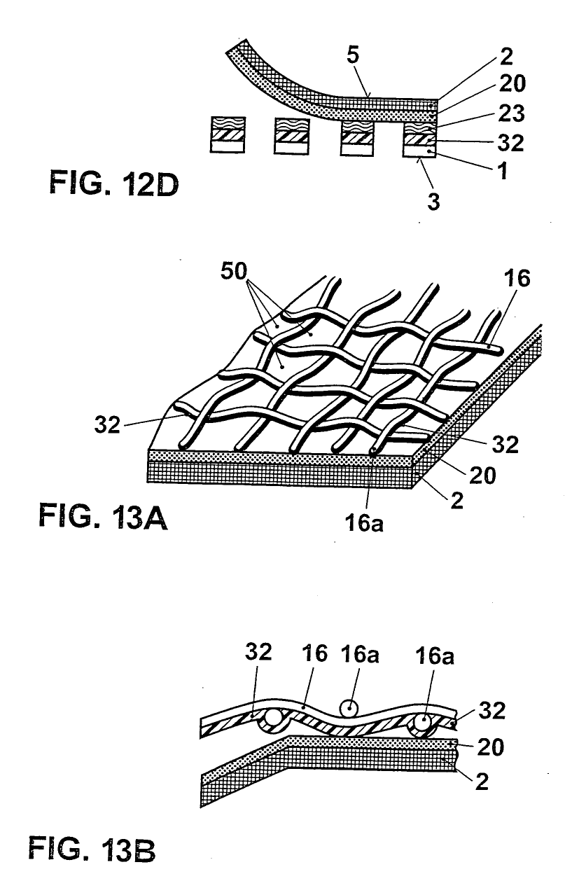

FIGS. 12A-12D show for a sticky material, like the one shown in FIG. 11, an improvement achievable by the present invention. By not anymore using a common liner for covering the adhesive layer 20, but a poster material according to the present invention with a light absorbing layer 32 on the side 4 of the poster substrate 1 being oriented towards the adhesive layer (FIG. 12A), the complex perforation procedure can be carried out simultaneously for two poster materials, for a poster material comprising a layer of adhesive material (in the scope of the present invention, such adhesive poster material is in general referred to as carrier material), which will be processed further to a sticky poster as known from the state of the art, and for an inventive poster material that is free of an adhesive layer (FIG. 12B).

FIG. 12C shows the separation of a poster material provided with an adhesive layer from a poster material free of an adhesive layer. Alternatively, the procedure of FIG. 12A to FIG. 12C might also be applied for simultaneously manufacturing two inventive, punched non-adherent poster materials, namely when, e.g. a separable compound material free of any adhesive layer were used. Such materials comprise coextrusion products and welded products.

In a further process step of the present invention, an adhesive coated, not perforated carrier is applied onto the adhesive free poster material (FIG. 12D). This step is only necessary or desirable when the printing apparatus construction does not provide any means by which a pollution of the light absorbing side during the printing procedure can at least be reduced and may be completely avoided. Such means are e.g. a sucking (exhaust) device, or the simultaneous supply of a covering foil that can be pressed onto the poster material, or a roll provided with an adequate surface. If the material is adequately chosen, not only the surface 3 of the poster material can subsequently be printed with information 30, but also the surface 5 of the carrier material with information 21.

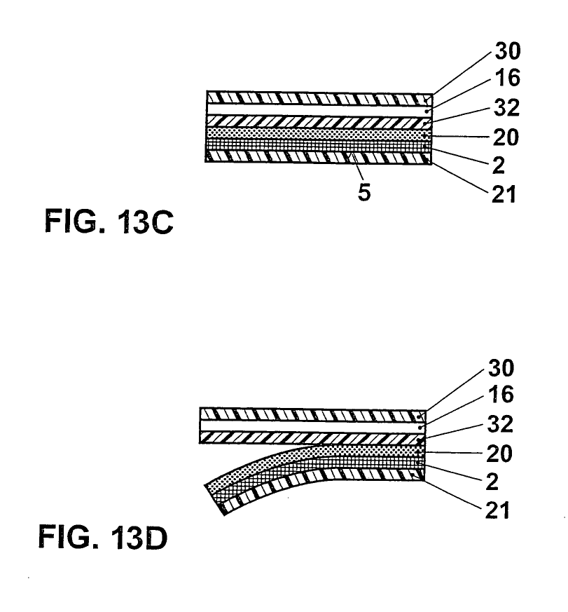

FIGS. 13A-13D show an analogous material, whereby in this embodiment the poster material does not need to be perforated, since it is a loose, and thus already “holes” comprising, light permeable fibrous material 16, 16A, e.g. a fabric. This fibrous material 16, 16A is one-sided light absorbingly coated (FIG. 13A) such that the regular, light permeable structure of the fibrous material 16, 16A is not affected. For easy processing in various printing apparatuses, this one sided light absorbingly coated fibrous material 16, 16A is then bonded with its light absorbing side 4 onto a self adhesive, separable foil 2, 20 (FIG. 13B). This foil, the carrier, shall be at least as elastic and as soft, that upon application of a certain pressure it is nestled to the light absorbing side 4 of the fibrous material such that the light absorbing side 4 is not soiled during the printing procedure.

FIG. 13C shows an exemplary embodiment, wherein not only the fibrous material 16, 16A comprises information 30 but also the carrier material 2, 20, 5 is provided with information 21. As already more than once described above, after having been printed with information 30, the carrier material 2, 20, 5 can be peeled off the inventive poster 32, 16, 30 and its adhesive layer can be covered with a foil comprising a separation/release layer (FIG. 13D).

In a further embodiment of the present invention and analogous to the above description also an “open work” poster material can be manufactured whose light reflecting side 3 is provided with a metallization which does not need to be printable. Such a material, for example, is adequate to be used as a reflective covering of glass panes, e.g. of winter gardens.

1-33. (canceled)

34. An adhesion compound for use in producing non-adhesive posters, the adhesion compound comprising:
at least a poster material with a poster substrate; and
a carrier material with a carrier substrate;
wherein:
the poster material and said carrier material are separably connected together by an adhesive layer,
the poster material has on a first side a printable or with an image receptive coating directly or after pre-treatment providable surface and on a second side a light absorbing surface,
the adhesive layer has a better adhesion towards the carrier material than towards said poster material such that after separation of the poster material and the carrier material the adhesive layer remains on the carrier material, and
the poster material has in at least an area regularly or in a regular pattern distributed holes, such that in separated form it is see-through from the second side with the light absorbing surface.

35. The adhesion compound of claim 34, wherein the side of the poster material facing the carrier material is the second side with the light absorbing surface.

36. The adhesion compound of claim 34, wherein on the fist side the poster material has a printable surface.

37. The adhesion compound of claim 34, wherein the poster material has a first side with a surface that is directly or after pre-treatment providable with an image receptive layer/coating.

38. The adhesion compound of claim 34, wherein the first side of the poster material shows a surface which is also light reflective.

39. The adhesion compound of claim 34, wherein the carrier material has a first side with a surface which is printable or with an image receptive coating directly or after pre-treatment providable, and a second side with a surface which is light absorbing, the light absorbing second side of the carrier material facing the poster material.

40. The adhesion compound of claim 39, wherein the first side of the carrier material has a surface which is also light reflecting.

41. The adhesion compound of claim 34, wherein the poster material and the carrier material in at least one area have regularly distributed holes.

42. The adhesion compound of claim 34, wherein the holes are perforation or punching holes, respectively.

43. The adhesion compound of claim 34, wherein the carrier material has no holes.

44. The adhesion compound of claim 43, wherein the first side of the poster material is provided with information.

45. The adhesion compound of claim 34, wherein the first side of the carrier material has a surface which is printable per se or due to an image receptive coating.

46. The adhesion compound of claim 34, wherein the surface of the first side of the carrier material is printed on with information.

47. The adhesion compound of claim 34, wherein a surface of at least one of (i) at least one of the first side and the second side of the poster material, and (ii) at least one of the first side and the second side of the carrier material are at least one of light absorbing and light reflecting due to one of a layer applied to the respective side, and to dyeing of the poster substrate or of the carrier substrate.

48. The adhesion compound of claim 34, wherein at least one of the poster substrate and the carrier substrate are compound materials.

49. The adhesion compound of claim 34, wherein at least one of the following is satisfied: (i) at least one of the first side of the poster material and the first side of the carrier material have a surface, which is white or appears metalized; and (ii) at least one of the light absorbing surface of the second side of the poster material and the carrier material appears black.

50. The adhesion compound of claim 34, wherein at least one area of the poster material and the carrier material is provided with regularly distributed holes, such that the holes have a diameter of 1 to 5 mm, and that the holes amount to 30 to 60%, of all the areas with regularly distributed holes.

51. The adhesion compound of claim 34, wherein at least one of the following is satisfied: (i) the poster material and the carrier material include a light absorbingly colored paper or a light absorbing layer coated paper; (ii) the poster material includes a light absorbingly colored plastic foil or a plastic foil that is coated with a light absorbing layer; (iii) at least one of the poster material and the carrier material include a multilayer compound material, or a compound material made of several plastics, or a compound made of at least one of paper and plastics and at least one further material; and (iv) the poster material includes a pulp fabric.

52. The adhesion compound of claim 34, wherein at least one of the poster material and the carrier material are provided with one of: (i) at least one auxiliary layer on the second side of the poster material; and (ii) an auxiliary layer to improve a printability on the first side of the poster material and the carrier material.

53. The adhesion compound of claim 34, wherein the adhesion compound is provided with information and with at least one additional layer over the information.

54. The adhesion compound of claim 34, wherein the carrier material is on both sides provided with an adhesive layer, the carrier material being on both sides provided with poster material.

55. The adhesion compound of claim 34, wherein the carrier material is only on one side in contact or provided with an adhesive layer.

56. The adhesion compound of claim 34, wherein a sum of all areas having holes of the poster material is at least 50% of a total area of the adhesion compound or the poster material, respectively.

57. The adhesion compound of claim 34, wherein the carrier material has a first side with a surface which is printable or with an image receptive coating directly or after pre-treatment providable, and a second side with a surface which is light absorbing.

58. The adhesion compound of claim 34, wherein the carrier material is continuous and not holey, and the light absorbing surface of the poster material faces the adhesive layer and the carrier material.

59. A method for producing a one-sided see-through, non-adhesive poster, the method comprising:
providing a printable adhesion compound, including at least a poster material with a poster substrate and a carrier material with a carrier substrate, by separately joining the poster material and the carrier material together by an adhesive layer, the poster material having on a first side a printable surface that is light reflecting and on a second side a light absorbing surface, and by providing the poster material with holes in at least one area such that it is one-sided see-through, the poster material after separation from the carrier material being free from any adhesive layer;
printing information on the first side of the poster material and optionally on the first side of the carrier material; and
separating the poster material from the carrier material;
wherein in the adhesion compound, the adhesive layer has a better adhesion towards the carrier material than towards said poster material such that after separation of the poster material and the carrier material the adhesive layer remains on the carrier material, and the poster material has in at least an area regularly or in a regular pattern distributed holes, such that in separated form it is see-through from the second side with the light absorbing surface.

60. A method for producing a printable adhesion compound, the method comprising:
removably adhering or bonding a poster material, which has on a first side a printable surface, an image receptive coating directly providable surface or an after pre-treatment providable surface, and on a second side a light absorbing surface, and in at least an area holes that are regularly or in a regular pattern distributed, such that in separated form it is see-through from the second side with the light absorbing surface, to a non-holey carrier material by an adhesive layer, wherein the adhesive layer has a better adhesion towards the carrier material than towards the poster material such that after separation of the poster material and the carrier material the adhesive layer remains on the carrier material.

61. The method of claim 60, wherein the poster material that is one-sided, see-through in at least one area is produced in that a poster material, which includes on a first side a printable surface or a surface that can directly or after pre-treatment be provided with an image receptive coating and that on a second side has a light absorbing surface, is provided with holes in at least one area by perforation.

62. The method of claim 60, wherein:
the poster material that is one-sided, see-through in at least one area is produced in that a base adhesion compound includes at least a poster material with a poster substrate and a carrier material with a carrier substrate,
the poster material and the carrier material are separably connected or joined together by an adhesive layer,
the poster material has on a first side a printable or with an image receptive coating directly or after pre-treatment providable surface and on a second side a light absorbing surface,
the adhesive layer has a better adhesion towards the carrier material than towards the poster material such that after separation of the poster material and the carrier material the adhesive layer remains on the carrier material, at least one area being provided with holes by perforation, the holes going through the whole adhesion compound, and the poster material and the carrier material being separated.

63. The method of claim 62, wherein the base adhesion compound is produced in that a non-holey poster material or a substrate with a printable surface or a surface that is directly or after pre-treatment providable with an image receptive layer on its first side and with a light absorbing surface on its second side is made by either applying a light absorbing coating to the surface of the second side of the poster substrate, the poster substrate providing the first surface, or by producing a laminate of a light absorbing layer and a printable layer or a layer that is directly or after pre-treatment providable with an image receptive layer, the produced poster material then being coupled with a carrier material such that after separation from the carrier material, the poster material does not have any adhesive properties.

64. The method of claim 60, wherein the carrier material used on a first side has a printable surface or a surface that is directly or after pre-treatment providable with an image receptive layer and that on a second side has a light absorbing surface, and wherein the carrier material on the second side with the light absorbing surface has an adhesive layer.

65. The method of claim 60, wherein the poster material is provided with at least one of an image receptive layer, a light reflecting surface, and at least one auxiliary coating in any step for producing the printable adhesion compound.

66. A method for distributing information, the method comprising:
providing that a poster material, which has no adhesion coating on a first side nor on a second side, is hung up, hung against a window or placed on a surface;
wherein the poster material includes:
regularly distributed holes in at least an area and having on the first side a surface which is light reflecting and which carries information on the light reflecting first side and a light absorbing surface on the second side,
on a first side a printable or with an image receptive coating directly or after pre-treatment providable surface and on a second side a light absorbing surface, and
in at least an area regularly or in a regular pattern distributed holes, such that in separated form it is see-through from the second side with the light absorbing surface.

67. The adhesion compound of claim 44, wherein the information includes at least one of an image and text.

68. The adhesion compound of claim 48, wherein at least one of the compound materials include laminates.

69. The adhesion compound of claim 49, wherein the metallization includes aluminization.

70. The adhesion compound of claim 50, wherein at least one of the following is satisfied: the holes have a diameter of 1 to 2 mm; the holes amount to 30 to 50% of all the areas with regularly distributed holes; and the holes include round holes.

71. The adhesion compound of claim 51, wherein at least one of the following is satisfied: (i) the multilayer compound material includes paper, plastics or synthetic material; and (ii) the pulp fabric includes at least one of an open work fabric made of textile fibers and synthetic fibers.

72. The adhesion compound of claim 52, wherein the at least one auxiliary layer includes at least one of a translucent/transparent, separation/release layer and a protection layer.

73. The adhesion compound of claim 53, wherein the at least one additional layer includes at least one protective layer for protecting against degradation of abrasion, for enhancing a light fastness/light resistance, for enhancing a weather resistance, and for protecting against graffiti.

74. The adhesion compound of claim 54, wherein the poster material includes holes.

75. The adhesion compound of claim 56, wherein at least one of the following is satisfied:
(i) the sum of all areas having holes of the poster material and a sum of all areas having holes of the carrier material is one of: at least 50% of the total area, at least 75% of the total area, at least 90% of the total area, and about 100% of the total area; and
(ii) the sum of all areas having holes of the carrier material is 0% or identical to the sum of all areas having holes of the poster material.

76. The method of claim 59, further comprising:
providing at least one of the first side of the poster material and the first side of the carrier material with a protection layer over the information.

77. The method of claim 60, further comprising:
providing an image receptive coating and/or a light reflecting coating.

78. The method of claim 65, wherein the poster material and the carrier material are provided with at least one of the image receptive layer, the light reflecting surface, and the at least one auxiliary coating.

79. The method of claim 66, further comprising: stabilizing with a frame.
